(19) United States
(12) Patent Application Publication
(10) Pub. No.: US 2019/0197612 A1
(43) Pub. Date: Jun. 27, 2019

(54) REQUEST FOR QUOTE SYSTEM AND METHOD

(71) Applicant: CFPH, LLC, New York, NY (US)

(72) Inventors: Laurence Rose, New York, NY (US); Dean P. Alderucci, Westport, CT (US)

(21) Appl. No.: 16/291,633

(22) Filed: Mar. 4, 2019

Related U.S. Application Data
(63) Continuation of application No. 12/439,030, filed on Oct. 9, 2009, now abandoned.
(60) Provisional application No. 60/840,528, filed on Aug. 28, 2006.

(51) Int. Cl. G06Q 30/08; G06Q 30/06; G06Q 40/06

(52) U.S. Cl. CPC G06Q 30/08; G06Q 40/06; G06Q 30/0601

(57) ABSTRACT

Provided are request-for-quote (RFQ) systems and methods in which quotes received in response to a RFQ are held until a condition is met and only released for display when that condition is met.

### BRIEF DESCRIPTION OF THE DRAWINGS

The following detailed description will be better understood by reference to the drawings, in which

FIG. 1 depicts an exemplary request-for-quote (RFQ) trading system.

FIG. 2 depicts a diagrammatic view of a server that may be used in the RFQ trading system.

FIG. 3 depicts a flow chart illustrating a method of requesting quotes and displaying the received quotes if a condition is met according to an embodiment of the present invention.

FIG. 4 depicts a flow chart illustrating a method of determining whether a condition is met; and transmitting, if the condition is met, quotes received in response to a RFQ according to an embodiment of the present invention.

FIG. 5 depicts a flow chart illustrating a method of receiving quotes in response to a plurality of RFQs and transmitting to each user submitting an RFQ the received quotes determined to belong to the user if a condition is met according to an embodiment of the present invention.

### DETAILED DESCRIPTION

Previously described RFQ systems and methods allow responses (quotes) to a RFQ pass through to the recipient (usually the requestor or requestor's agent) substantially as they are received. Accordingly, nothing prevents the recipient from accepting the first quote (or other quote that isn't necessarily the quote with the highest price or otherwise the best quote) received in response to a RFQ. Particularly in the context of trading securities and financial instruments on a regulated exchange (i.e., the over-the-counter market) wherein RFQ systems are used, it is desirable that a buyer of a security or financial instrument be able to assess a set (e.g., a predetermined set) of quotes. For example, in certain embodiments it can be desirable to make a selection select the quote with the best price (e.g., from amongst the set) rather than, e.g., selecting the first. Thus, a RFQ system used in such a trading process could benefit from collect a number of quotes received in response to a RFQ before releasing them to a buyer, in order to prevent or impede acceptance of the first quote that is received rather than the best quote of a set of quotes received. It is also desirable that a buyer engage in an arm's-length transaction, that is, select the quote with the best price, not a quote simply because it originated from a friend or other interested party. Thus, the RFQ system used in such a trading process could benefit from recording whether a particular number of quotes was received and/or which quote of the set was accepted. Such recording would to enable reporting, e.g., that the trade complied with regulations, that the best price was accepted and/or that the trade appeared to be at arm's-length.

Accordingly, provided are RFQ systems and methods in which quotes received in response to a RFQ are held until a predetermined condition is met and only released for display when that condition is met. The condition may be any condition, such as a condition that ensures that more than one quote is received prior to releasing the quotes for display, for example, whether a certain period of time for receiving quotes has elapsed, and/or that a particular number of quotes was received. The condition may be set by a user of the system, e.g. via a command, the condition may be set by an administrator of the system. Some conditions, such as a condition that is set by an administrator, may not able to be changed by a user. Some conditions are applicable to all users. The system may comprise means for logging or recording the activities of the system as various methods are implemented on the system, such as what conditions were set and by whom, whether the conditions were met, which conditions were met, what responses to RFQs were chosen, whether chosen quotes were the “best” (according to criteria such as lowest price, highest price), etc.

For convenience, before further description of the invention, certain terms employed in the specification, examples, and appended claims are collected here. Unless defined otherwise, all technical and scientific terms used herein have the same meaning as commonly understood by one of ordinary skill in the art to which this invention belongs.

The articles “a” and “an” are used herein to refer to one or to more than one (i.e., to at least one) of the grammatical object of the article.

The phrase “based on” does not mean “based only on”, unless expressly specified otherwise. In other words, the phrase “based on” describes both “based only on” and “based at least on”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. The term “determining” does not imply certainty or absolute precision, and therefore “determining” can include estimating, predicting, guessing and the like. The term “determining” does not imply that mathematical processing must be performed, and does not imply that numerical methods must be used, and does not imply that an algorithm or process is used. The term “determining” does not imply that any particular device must be used. For example, a computer need not necessarily perform the determining

The terms “including”, “comprising” and variations thereof mean “including but not limited to”, unless expressly specified otherwise.

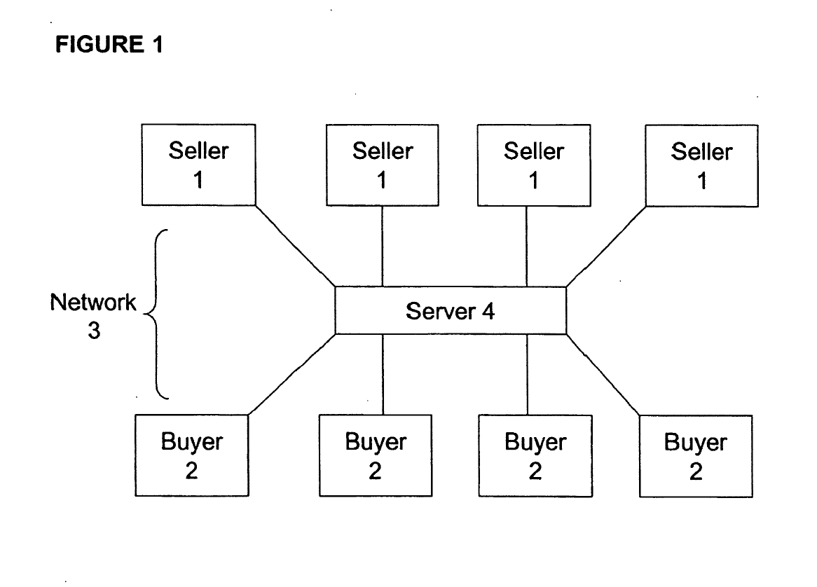

Turning now to the drawings, FIG. 1 is a block diagram overview of a system for trading products using RFQs according to an embodiment of the present invention. The system includes a number of seller devices 1 coupled to a number of buyer devices 2 through a communication network 3. The buyer devices 2 may be, for example, Personal Computers (PCs), Personal Digital Assistants (PDAs), wired or wireless telephones, or any other communication device. The communication network 3, which may comprise a server 4 may comprise, for example, a Local Area Network (LAN), a wireless network, a Public Switched Telephone Network (PSTN), or an Internet Protocol (IP) network such as the Internet, an intranet or an extranet. The server 4 may be used for processing, storing, routing and releasing RFQs and quotes in response to RFQs in accordance with the present invention. In certain embodiments, some or all of the steps and methods described as being implemented by the system may be performed by the remote terminals rather than by the server. For example, determination of whether a condition has been met may be performed either on the server or on a remote terminal. Further, quotes and/or conditions may be stored on a server or on a remote terminal.

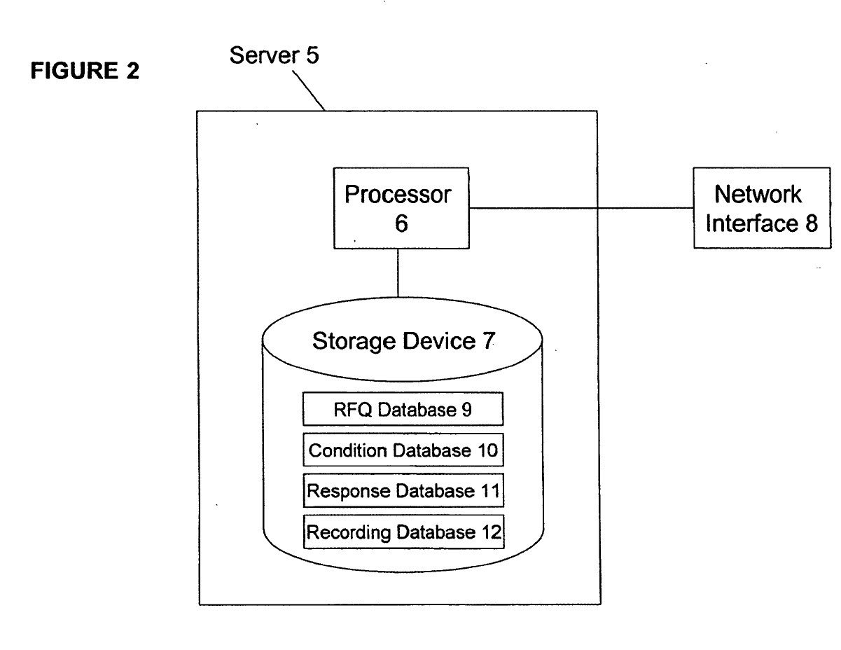

Referring to FIG. 2, the server 5 includes a processor 6 connected to a storage device 7 and to a network interface 8. The storage device 7 may include at least four databases, for example, a RFQ database 9, a condition database 10, a response to RFQ database 11 and a recording database 12. The storage device 7 further includes the necessary software for operating server 5 in accordance with the processes described in detail herein.

The server 5 may comprise one or more of any of many conventional computer servers, for example an IBM RS6000®, programmed to operate in accordance with the present invention. Storage device 7 comprises an appropriate memory device, for example including an appropriate combination of semiconductor, magnetic, and optical memory. The network interface 8 can comprise standard network interface hardware and software.

Both buyer and seller devices may be terminal devices. In contrast to server 5 described above, terminal devices typically require less processing power, less communication throughput. More specifically, terminals include a processor, a network interface, and a storage device. Processor may comprise, for example, an Intel Pentium® compatible processor. Network interface comprises an appropriate network interface device, such as a network interface card. Storage device comprises an appropriate memory device, for example including an appropriate combination of semiconductor, magnetic, and optical memory, and is seen to include at least one database, which stores local data, for example, RFQs or responses to RFQs in embodiments where the terminal processes the responses to RFQ rather than the server. Terminals further include input devices and output devices. Input devices and output devices includes appropriate devices for communicating data between a human operator and terminal, for example a video display device, a printer, a mouse, a keyboard, and a printer.

By way of example only, in another embodiment, the seller device may be a Web-based server communicating with a number of PCs through the Internet.

Exemplary architectures suitable for implementing RFQ systems are described in U.S. Pat. No. 5,842,178, which is expressly incorporated herein by reference in its entirety.

The system provides a platform for trading products such as commodities and financial instruments: equities, U.S. treasury securities, FX Spot, FRAs, Forwards and also FX Forwards, CFDs, short-dated government and/or central bank paper, commercial bills, CDs, inter-bank deposits, commercial paper, reports, interest-rate futures, swaps, options, commodities such as metals and a miscellany of variants on these financial instruments.

According to an embodiment of the present invention, a buyer using a buyer device submits a RFQ to the network. A RFQ is an instruction submitted at a buyer device that requests a price for a product. The RFQ is sent to at least one of the seller devices via the communication network. For example, the buyer device may send the RFQ as an email or application-specific data to a number of seller devices. Information about the RFQ, such as the identity and/or location of the buyer device on the communication network, may be stored on the server or on the seller device to which the RFQ is sent, or stored within (or otherwise derivable from) the RFQ instruction itself.

A seller at a seller device may submit a response to a RFQ received at the seller device to the network. A response to an RFQ is an instruction submitted at a seller device, and the instruction defines a price. Depending on the context, a price may represent a bid, i.e., a price for the product the seller wishes to buy. The price may represent an offer, i.e. a price for the product the seller wishes to sell. The response to RFQ may be routed to the buyer device from which the RFQ originated and is held, i.e., stored, on the buyer device before it is released for display, or may be held on the server in the communications network before it is routed to the buyer device after it is determined by the buyer terminal processor or server processor that the condition is met. Once it is determined that the condition has been met (e.g., at least three quotes have been received), the response to RFQ is released for display on the buyer terminal, e.g. on a display device or printer.

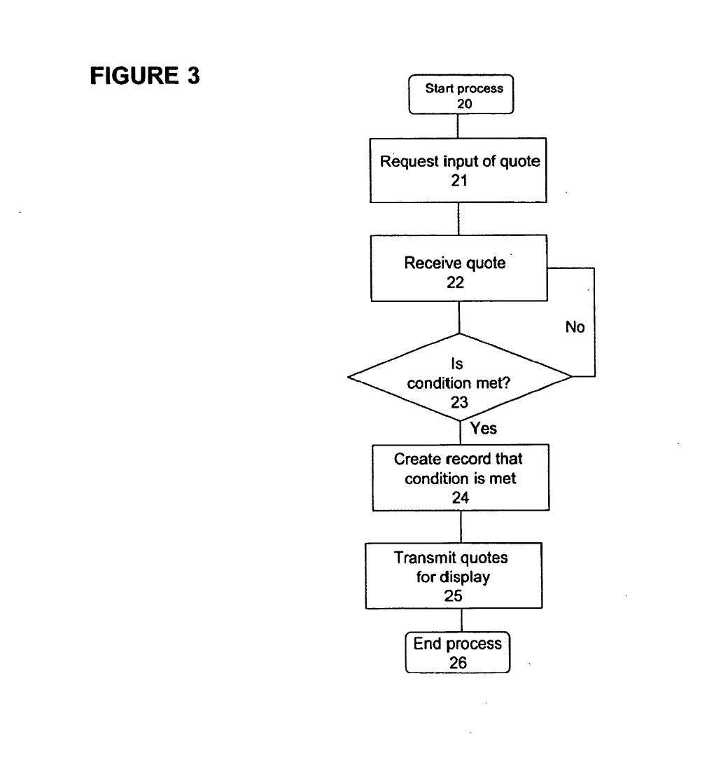

FIG. 3 is a flow chart illustrating a method of requesting quotes and displaying the received quotes if a condition is met according to an embodiment of the present invention. The flow chart in FIG. 3, as well as the other flow charts discussed herein, are not meant to imply a fixed order to the steps; an embodiment of the present invention can be practiced in any order that is practicable.

As shown in FIG. 3, at the beginning of the process, a request 21 for at least one quote for the price of a product is sent. Quotes in response to the request are received 22, and optionally stored or queued. In step 23, it is determined whether the condition has been met. If not, in one embodiment further quotes in response to the request are permitted to be received. When it is determined that the condition has been met, a record 24 is created that the condition has been met. The record may store other information, such as how the condition was met, what time the condition was met, the received quotes. The received quotes are displayed 25, for example, by displaying the quotes, e.g. on a display device or printer, before the process ends in step 26. The quotes may be displayed based at least in part on respective times at which the quotes were received or by some characteristic of the quotes (e.g., the identity of the sender of the quotes, or the entity the sender is working for, the price of the quotes). For example, the quotes may be displayed in order of decreasing or increasing price, or may be displayed by showing only the price (and possibly other information such as the quantity) but not the identity of the sender.

The process shown in FIG. 3 may additionally comprise steps for receiving the condition, e.g., by command, and for accessing the condition. The process shown in FIG. 3 may comprise additional recording steps for recording any step of the process, for example, the requesting step, the receiving steps, the condition, the progress toward meeting the condition, etc. The process shown in FIG. 3 may further comprise displaying the condition, for example, when it is met, or displaying the progress toward meeting the condition. It may also comprise indicating the quotes to which the condition applies.

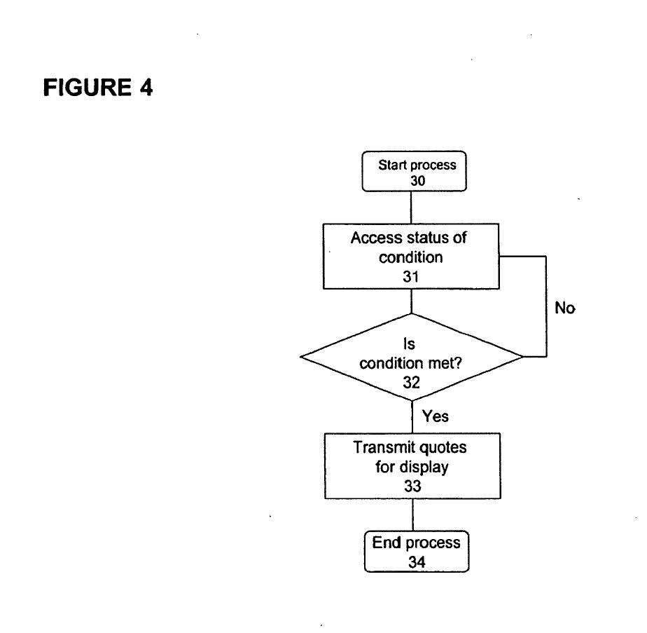

FIG. 4 depicts a flow chart illustrating a method of determining whether a condition is met; and transmitting, if the condition is met, quotes received in response to a RFQ according to an embodiment of the present invention. As shown in FIG. 4, at the beginning of the process 30, the status of the condition is accessed (i.e., the time elapsed or number of quotes received) 31, and it is determined whether the condition has been met 33. If the condition has been met, quotes received in response to at least one RFQ for a price of a product are transmitted 34.

The process shown in FIG. 4 may additionally comprise steps for receiving a RFQ and/or receiving quotes in response to the a RFQ. Further, the process shown in FIG. 4 may additionally comprise transmitting to a display device, e.g. of a buyer device, the quotes received in response to the at least one RFQ if the condition is met. The process in FIG. 4 may also comprise requesting and/or receiving the condition from a user issuing the at least one RFQ. The process in FIG. 4 may also comprise transmitting an indication that the condition is met prior to transmitting the quotes, e.g., to a display device, or transmitting the condition that is being used to a user issuing the RFQ, so that the user knows the condition being applied. Instead of transmitting the condition, instead, the process may comprise allowing a user to access the condition. The process may also comprise verifying that a user accepted a condition.

The process of FIG. 4 may also further comprise recording steps, such as recording the condition and whether it was approved by a user, recording the received quotes, and details of the receiving and requesting steps, such as the time at which an RFQ is received or the origin of a RFQ that is received. The process of FIG. 4 may also comprise storing or queuing the received RFQs.

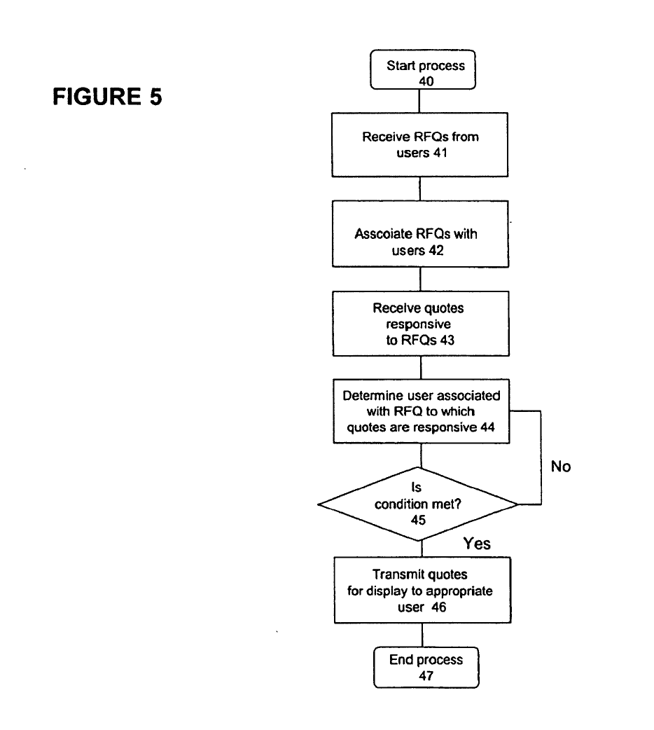

FIG. 5 depicts a flow chart illustrating a method of receiving quotes in response to a plurality of RFQs and transmitting to each user submitting an RFQ the received quotes determined to belong to the user if a condition is met according to an embodiment of the present invention. As shown in FIG. 5, after the start of the process 40, a plurality of RFQs are received 41. Each RFQ is associated with the user from which it originated 42. Quotes are received 43 in response to the received RFQs. The process determines 44 which of the received quotes belong to each user based on the RFQs. Once it determines whether a condition has been met 45, the received quotes determined to belong to the user are transmitted 46 to the user's terminal.

In certain variations of the process in FIG. 5, the condition is associated with the user to which the quotes are transmitted, such that each user may have a particular condition that needs to be met before the quotes are released to the user. In such variations, the process may further comprise receiving the condition for a particular user. In other variations, the condition is the same for all users.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof.

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

Additional Embodiments

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims. Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

For example, in addition to the embodiments disclosed herein, including the claims appended hereto, the following paragraphs set forth additional, non-limiting embodiments (with all references to paragraphs contained in this section referring to other paragraphs set forth in this section):

1. A method comprising:

A. requesting at least one quote for a price of a product; and

B. displaying quotes received in response to the act A if a condition is met.

2. The method of paragraph 1, wherein the act B comprises displaying on a display device the quotes received in response to the act A if the condition is met.

3. The method of paragraph 1, wherein the product is a financial instrument.

4. The method of paragraph 3, wherein the financial instrument comprises an unregulated financial instrument.

5. The method of paragraph 4, wherein the unregulated financial instrument comprises a U.S. treasury security.

6. The method of paragraph 1, wherein the condition is whether at least a predetermined number of the quotes has been received.

7. The method of paragraph 6, wherein the predetermined number of the quotes is three.

8. The method of paragraph 1, wherein the condition is whether a certain period of time has elapsed since the act A.

9. The method of paragraph 1, further comprising receiving the condition.

10. The method of paragraph 9, comprising receiving the condition via command.

11. The method of paragraph 1, wherein the condition is predetermined.

12 The method of paragraph 1, further comprising accessing a condition.

13. The method of paragraph 1, wherein the condition is predetermined and cannot be altered by a user.

14. The method of paragraph 1, wherein the condition is inaccessible to the user.

15. The method of paragraph 1, further comprising recording the act A.

16. The method of paragraph 1, further comprising recording the act B.

17. The method of paragraph 1, further comprising recording the acts A and B.

18. The method of paragraph 1, further comprising displaying the condition.

19. The method of paragraph 1, further comprising displaying the condition when the condition is met.

20. The method of paragraph 1, further comprising displaying the condition only if the condition is met.

21. The method of paragraph 1, further comprising not displaying the condition.

22. The method of paragraph 1, further comprising recording the condition.

23. The method of paragraph 22, further comprising accessing the recorded condition.

24. The method of paragraph 1, further comprising approving the condition.

25. The method of paragraph 24, further comprising recording whether the condition is approved.

26. The method of paragraph 22, further comprising recording whether the condition is met.

27. The method of paragraph 1, further comprising displaying whether the condition is met.

28. The method of paragraph 1, further comprising recording the progress toward meeting the condition.

29. The method of paragraph 1, further comprising displaying the progress toward meeting the condition.

30. The method of paragraph 1, further comprising indicating the quotes to which the condition applies.

31. The method of paragraph 1, further comprising displaying the quotes based at least in part on respective times at which the quotes were received.

32. The method of paragraph 1, further comprising displaying the quotes based at least in part on a characteristic of the quotes.

33. The method of paragraph 32, wherein the characteristic of the quotes is the price designated in the quotes.

34. The method of paragraph 32, wherein the characteristic of the quotes is an identity of a submitter of each quote.

35. A method comprising:

A. requesting at least one quote for a price of a product; and

B. displaying quotes received in response to the act A only if a condition is met.

36. A method comprising:

A. requesting at least one quote for a price of a product; and

B. withholding from display the quotes received in response to the act A unless a condition is met.

37. A method comprising:

A. requesting at least one quote for a price of a product;

B. storing quotes received in response to the act A; and

C. displaying the stored quotes if a condition is met.

38. A method comprising:

A. requesting at least one quote for a price of a product;

B. storing quotes received in response to the act A; and

C. displaying the stored quotes only if a condition is met.

39. A method comprising:

A. requesting at least one quote for a price of a product;

B. queuing quotes received in response to the act A; and

C. displaying the queued quotes if a condition is met.

40. A method comprising acts of:

A. requesting at least one quote for a price of a product;

B. queuing quotes received in response to the act A; and

C. displaying the queued quotes only if a condition is met.

41. A method comprising:

A. requesting at least one quote for a price of a product, wherein each quote received in response comprises a price; and

B. displaying quotes received in response to the act A if a condition is met.

42. A method comprising:

A. requesting at least one quote for a price of a product, wherein each quote received in response comprises a price; and

B. displaying quotes received in response to the act A only if a condition is met.

43. A method comprising:

A. requesting at least one quote for a price of a product, wherein each quote received in response is associated with the sender of the quote; and

B. displaying quotes received in response to the act A if a condition is met.

44. A method comprising:

A. requesting at least one quote for a price of a product, wherein each quote received in response is associated with the sender of the quote; and

B. displaying quotes received in response to the act A only if a condition is met.

45. A method comprising:

A. requesting at least one quote for a price of a product, wherein each quote received in response comprises a price and the name of the sender of the quote; and

B. displaying quotes received in response to the act A if a condition is met.

46. The method of paragraph 45, wherein the act B comprises displaying the name but not the price of the quotes received in response to the act A if a condition is met.

47. The method of paragraph 45, wherein the act B comprises displaying the name but not the price of the lowest quotes received in response to the act A if a condition is met.

48. A method comprising:

A. requesting at least one quote for a price of a product, wherein each quote received in response comprises a price and the name of the sender of the quote; and

B. displaying quotes received in response to the act A only if a condition is met.

49. The method of paragraph 48, wherein the act B comprises displaying the name but not the price of the quotes received in response to the act A only if a condition is met.

50. The method of paragraph 48, wherein the act B comprises displaying the name but not the price of the lowest quotes received in response to the act A only if a condition is met.

51. A method comprising:

A. determining whether a condition is met; and

B. transmitting, if the condition is met, quotes received in response to at least one RFQ for a price of a product.

52. A method comprising:

A. determining whether a condition is met; and

B. transmitting, only if the condition is met, quotes received in response to at least one RFQ for a price of a product.

53. The method of paragraph 51, further comprising receiving the at least one RFQ.

54. The method of paragraph 51, further comprising receiving quotes in response to the at least one RFQ.

55. The method of paragraph 51, further comprising storing quotes received in response to the at least one RFQ.

56. The method of paragraph 53, further comprising storing the quotes received in response to the at least one RFQ.

57. The method of paragraph 51, further comprising queuing the quotes received in response to the at least one RFQ.

58. The method of paragraph 53, further comprising queuing the quotes received in response to the at least one RFQ.

59. The method of paragraph 51, wherein the act B comprises transmitting to a display device the quotes received in response to the at least one RFQ if the condition is met.

60. The method of paragraph 59, wherein the display device is a local display device.

61. The method of paragraph 56, wherein the display device is a remote terminal.

62. The method of paragraph 49, wherein the product is a financial instrument.

63. The method of paragraph 58, wherein the financial instrument comprises an unregulated financial instrument.

64. The method of paragraph 63, wherein the unregulated financial instrument comprises a U.S. treasury security.

65. The method of paragraph 51, further comprising receiving the condition from a user issuing the at least one RFQ.

66. The method of paragraph 51, wherein the condition is predetermined.

67. The method of paragraph 66, wherein the condition is predetermined and cannot be altered by a user issuing the at least one RFQ.

68. The method of paragraph 51, further comprising transmitting an indication that the condition is met prior to transmitting the quotes.

69. The method of paragraph 51, further comprising transmitting the condition to a user issuing the at least one RFQ.

70. The method of paragraph 51, further comprising not transmitting the condition to a user issuing the at least one RFQ.

71. The method of paragraph 51, further comprising recording the condition.

72. The method of paragraph 51, further comprising requesting the condition.

73. The method of paragraph 51, further comprising recording the acts A and B.

74. The method of paragraph 53, further comprising storing the at least one received RFQ.

75. The method of paragraph 53, further comprising queuing the at least one received RFQ.

76. The method of paragraph 53, further recording the at least one received RFQ.

77. The method of paragraph 53, further recording the time at which an RFQ is received.

78. The method of paragraph 53, further recording the origin of a RFQ that is received.

79. The method of paragraph 54, further recording the received quotes.

80. The method of paragraph 54, further recording the time at which a quote is received.

81. The method of paragraph 54, further recording the origin of a received quote.

82. The method of paragraph 51, further comprising requesting a user to approve the condition.

83. The method of paragraph 82, wherein the user issues the at least one RFQ.

84. The method of paragraph 82, wherein the user provides a quote in response to at least one RFQ.

85. The method of paragraph 82, further comprising recording whether the condition was approved by a user.

86. The method of paragraph 82, further comprising verifying that a user approved the condition.

87. The method of paragraph 51, further comprising disclosing the condition to a user.

88. The method of paragraph 51, further comprising not disclosing the condition to a user.

89. The method of paragraph 51, further comprising allowing a user to access the condition.

90. The method of paragraph 51, further comprising not allowing a user to access the condition.

91. A method comprising:

A. receiving quotes in response to a plurality of requests for quote (RFQs) for a price of a product, wherein each RFQ is associated with a user;

B. determining which of the received quotes belong to a user based on the RFQs; and

C. transmitting to the user the received quotes determined to belong to the user if a condition is met.

92. The method of paragraph 91, wherein;

the act B comprises determining, for each of a plurality of users, which of the received quotes belong to each user based on the RFQs; and

the act C comprises transmitting the received quotes determined to belong to each of the users if a condition is met.

93. The method of paragraph 92, wherein the act B comprises

act B1) determining which of the received quotes are responsive to each of the RFQs;

act B2) associating each of the RFQs with a user; and

act B3) determining which of the received quotes belong to a user based on the user's association with the RFQ to which the received quotes are responsive.

94. The method of paragraph 91, wherein the condition is associated with the user to which the quotes are transmitted.

95. The method of paragraph 91, wherein the condition is predetermined.

96. The method of paragraph 91, further comprising receiving the condition for a user.

97. A method comprising:

A. receiving quotes in response to a plurality of requests for quote (RFQs) for a price of a product, wherein each RFQ is associated with a user;

B. determining which received quotes are responsive to each of the RFQs; and

C. transmitting received quotes to a user associated with the RFQ to which the received quotes are determined to be responsive if a condition is met.

98. The method of paragraph 97, further comprising determining which of a plurality of users are associated with each of the RFQs.

The following sections I-X provide a guide to interpreting the present application.

I. Terms

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application” , unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” do not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

II. Determining

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

IV. Disclosed Examples and Terminology are not Limiting

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. § 1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

VI. Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

VII. 35 U.S.C. § 112, Paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function hat is a method, one structure for performing this method includes a computing device (e.g., a general purpose computer) that is programmed and/or configured with appropriate hardware to perform that function.

Also includes a computing device (e.g., a general purpose computer) that is programmed and/or configured with appropriate hardware to perform that function via other algorithms as would be understood by one of ordinary skill in the art.

VIII. Disclaimer

Numerous references to a particular embodiment does not indicate a disclaimer or disavowal of additional, different embodiments, and similarly references to the description of embodiments which all include a particular feature does not indicate a disclaimer or disavowal of embodiments which do not include that particular feature. A clear disclaimer or disavowal in the present application shall be prefaced by the phrase “does not include” or by the phrase “cannot perform”.

IX. Incorporation by Reference

Any patent, patent application or other document referred to herein is incorporated by reference into this patent application as part of the present disclosure, but only for purposes of written description in accordance with 35 U.S.C. § 112, paragraph 1 and enablement in accordance with 35 U.S.C. § 112, paragraph 1, and should in no way be used to limit, define, or otherwise construe any term of the present application where the present application, without such incorporation by reference, would not have failed to provide an ascertainable meaning, but rather would have allowed an ascertainable meaning for such term to be provided. Thus, the person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

1. (canceled)

2. A request for quote (RFQ) management system comprising:
a management server configured to evaluate and organize a plurality of RFQs for a product by controlling:
receiving, over a communication network, a first RFQ of the plurality of RFQs from a first computing device of a first submitter;
for the first RFQ of the plurality of RFQs, determining a first condition for quotes for the first submitter, in which the first condition includes receiving a minimum number of quotes in response to the first RFQ;
receiving, over the communication network, a second RFQ of the plurality of RFQs from a second computing device of a second submitter;
for the second RFQ of the plurality of RFQs, determining a second condition for quotes for the second submitter, in which the second condition includes a minimum amount of time passing after receiving the second RFQ;
computing that the first condition has been met before transmitting, over the communication network, to a third computing device of a first user, first display signals to cause display of first quotes on a display of the third computing device; and
computing that the second condition has been met before transmitting, over the communication network, to a fourth computing device of a second user, second display signals to cause display of at least one second quote on a display of the fourth computing device.

3. The system of claim 2 further comprising
a second display configured to display the first quotes in response to the first display signals.

4. The system of claim 2, wherein at least one of the first computing device, the second computing device, the third computing device or the fourth computing device is a handheld device.

5. The system of claim 2, in which the product is a financial instrument.

6. The system of claim 5, in which the financial instrument comprises an unregulated financial instrument.

7. The system of claim 6, in which the unregulated financial instrument comprises a U.S. treasury security.

8. The system of claim 2, in which the first condition is set in advance of receiving the first RFQ.

9. The system of claim 2, in which the minimum number of quotes is set in the system by an administrator.

10. The system of claim 2, in which the minimum number of quotes is set in the system by a customer.

11. The system of claim 2, in which the minimum number is two.

12. The system of claim 2, in which the first condition is set in the system by the first submitter.

13. The system of claim 2, in which the first condition is set in the system by an administrator.

14. The system of claim 2, in which the first quotes are caused to be displayed in an order of receipt.

15. The system of claim 2, in which the first quotes are caused to be displayed by an identity of a sender of each quote.

16. The system of claim 2, in which the first quotes are caused to be displayed in an order of a price of each quote.

17. The system of claim 2, in which the first quotes are caused to be displayed with a price of each quote.
